(19) United States
(12) Patent Application Publication
(10) Pub. No.: US 2007/0109068 A1
(43) Pub. Date: May 17, 2007

(54) MULTI-LAYER SECURITY SYSTEM AND METHOD TO PREVENT UNAUTHORIZED ACCESS TO FUEL DISPENSER COMPARTMENTS

(75) Inventors: Leon B. Smith, Greensboro, NC (US); John S. McSpadden, Kernersville, NC (US); Lester Ward, Greensboro, NC (US); Dreama Sharpe, High Point, NC (US); Jonathan DeLine, Oak Ridge, NC (US)

Correspondence Address: WITHROW & TERRANOVA, P.L.L.C., 100 REGENCY FOREST DRIVE, SUITE 160, CARY, NC, 27518, US

(73) Assignee: Gilbarco Inc., Greensboro, NC (US)

(21) Appl. No.: 11/558,110

(22) Filed: Nov. 9, 2006

Related U.S. Application Data
(60) Provisional application No. 60/736,782, filed on Nov. 15, 2005.

(51) Int. Cl. H01P 1/32

(52) U.S. Cl. 333/1.1

(57) ABSTRACT

The present invention provides enhanced security to internal components in a main access compartment of a fuel dispenser. Both a primary lock on a main panel, that secures the main access compartment, and a hidden second lock, hidden inside a lower compartment of the fuel dispenser, must be bypassed to gain access to the internal components, thus providing enhanced security. The lower compartment is also protected by a lock, which must be bypassed in order to gain access to the hidden second lock in an attempt to bypass the hidden second lock. This locking arrangement provides greater security than prior art methods since three locks, including a hidden lock, must be bypassed to breach security and gain access to the internal components in the main access compartment of the fuel dispenser.

### RELATED APPLICATION

This application claims priority to Provisional Application Ser. No. 60/736,782, entitled “MULTI-LAYER SECURITY SYSTEM AND METHOD TO PREVENT UNAUTHORIZED ACCESS TO FUEL DISPENSER COMPARTMENTS,” filed on Nov. 15, 2005, and incorporated herein by reference in its entirety.

### FIELD OF THE INVENTION

This invention relates to a multi-layer fuel dispenser security system and method that prevents unauthorized access to the fuel dispenser and requires service personnel to engage the multiple layers of security to prevent unauthorized access to internal compartments of the fuel dispenser where sensitive components reside.

### BACKGROUND OF THE INVENTION

Service station environments provide fuel dispensers for consumers to dispense fuel into their vehicles. The fuel dispensers are typically comprised of a housing consisting of one or more compartments that contain internal fuel-handling, payment, and other components. For example, if the fuel dispenser is a Gilbarco® branded fuel dispenser equipped with a CRIND® payment device, card readers, printers, and other electronics, the circuitry that supports operation of these devices is located within an internal compartment of the dispenser housing. If an authorized service personnel desires to gain access to these internal components for servicing or other reasons, an access panel attached to the compartment must be opened.

Since the internal components of a fuel dispenser handle hazardous liquids, such as gasoline and diesel fuels, or because the dispensers may contain card readers and other payment devices that can be tampered with or tapped to “skim” customer data, it is important that these components remain securely enclosed within the fuel dispenser and inaccessible to the general public. Security is typically provided in the form of a key lock, wherein a key is required to unlock and open a panel that provides access to the internal compartments of the fuel dispenser. Only authorized personnel possessing the key are supposed to have access, but the key locks may be tampered with or damaged to bypass this requirement.

Some fuel dispensers, such as the Gilbarco® Trim-line® fuel dispenser and Legacy® Mechanical fuel dispenser, contain an additional latching mechanism that prevents the upper or main accessibility panel from being opened as an extra measure of security, in addition to a lock. The upper compartment is thought of as more sensitive, because payment devices transmitting customer payment data are typically located in the upper compartment. The latching mechanism for the upper compartment is hidden behind a lower panel of the fuel dispenser, so that both the lower panel and upper, or main access, panel must be opened to unlock the latch. Therefore, a key is used to unlock the lower panel, the latch in the lower compartment is disengaged, and the upper panel is unlocked to gain access to the upper compartment. In this manner, two locks, instead of one, protect access to the upper panel. However, in order for this additional security measure to be effective, service personnel must remember to engage the latch behind the lower panel properly. Service personnel often either forget to take this action, or refuse to do so, since the upper and lower panels of the fuel dispenser can still be closed properly without engaging the latch.

Therefore, a need exists to provide an enhanced and multiple layer security system to prevent opening of the upper or main access panel, even if its lock is bypassed, which requires without option, engagement all of the multiple security layers to prevent access to the main access compartment of the fuel dispenser. Otherwise, the additional layers of security are not guaranteed to be effective.

### SUMMARY OF THE INVENTION

The present invention provides enhanced security to the internal components in the main access compartment of a fuel dispenser. Both a primary lock on the main panel, that secures the main access compartment, and a hidden second lock, concealed inside a lower compartment of the fuel dispenser, must be bypassed to gain access to the internal components, thus providing enhanced security. The lower compartment is also protected by a lock, which must be bypassed to open the lower panel and gain access to the hidden second lock in an attempt to bypass the hidden second lock. This locking arrangement provides greater security than prior art methods, since three locks must be bypassed to breach security and gain access to internal components in the main access compartment of the fuel dispenser.

Further, according to the present invention, the main panel includes a hook, wherein the hook attaches to an inside lip on the lower portion of the main panel, and further attaches to a latch within the lower compartment of the fuel dispenser to secure the main panel from unauthorized access.

Several latch embodiments are applicable to the present invention. Generally, the latch contains a hook ring which attaches to the hook on the main panel of the fuel dispenser. The latch also comprises some mounting means, typically mounting screw holes, from which the latch is mounted to part of the fuel dispenser housing. Further the latch comprises a latch arm that is used to secure the latch in the closed position when the hook ring is attached to the hook on the main panel.

The preferred embodiment of the latch comprises a pad-lock acceptor for the addition of a standard pad-lock as the third lock in the security system. The latch also comprises a hook ring which is flat and square in shape.

Alternative embodiments of the latch are contemplated by the present invention and are disclosed. A first alternative embodiment of the latch comprises a pin-lock latch arm, which allows for the addition of a lock-pin for securing the latch arm in the closed position. This latch also comprises a radially curved hook ring. A second alternative embodiment of the latch comprises an alternative attachment means comprised of an edge-mounting clip. A third alternative embodiment of the latch comprises an alternative attachment means comprised of back and side mounting tabs. A fourth alternative embodiment of the latch comprises a mini-latch arm which is smaller in size than the previous latch arm embodiments. A fifth alternative embodiment of the latch comprises a mini-latch arm without a pin-lock hole. This embodiment also contains an alternative mounting means comprised of a latch base that extends beyond the edges of the mini-latch arm and where the mounting holes are aligned perpendicular to the length of the latch.

In accordance with the present invention, certain steps must be carried out to properly assemble and secure the main compartment of the fuel dispenser. These steps enhance security of the main panel of the fuel dispenser by providing the three levels of lock security.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is an illustration of a fuel dispenser in accordance with one embodiment of the present invention;

FIG. 2A is an illustration depicting a partially open main panel and detached lower panel of the fuel dispenser in accordance with one embodiment of the present invention;

FIG. 2B is an illustration depicting a ski-boot latch mechanism attached to a metal mounting brace mechanism in accordance with one embodiment of the present invention;

FIG. 2C is an illustration depicting a ski-boot latch embodiment coupled to the metal mounting brace mechanism which is further coupled to the fuel dispenser housing in accordance with one embodiment of the present invention;

FIG. 3A is an illustration depicting the ski-boot latch embodiment and hook illustrated in FIG. 2, wherein the latch is in the closed/locked position;

FIG. 3B is an illustration depicting the ski-boot latch embodiment and hook illustrated in FIG. 2, wherein the latch is in the open/unlocked position;

FIG. 4 is an illustration of an additional pad-lock mechanism provided as part of the ski-boot latch security in accordance with one embodiment of the present invention.

FIG. 5 is an illustration of an exploded view of the hook mechanism according to the present invention;

FIG. 6A is a side view illustration of the hook mechanism illustrated in FIG. 5, according to the present invention;

FIG. 6B is a top view illustration of the hook mechanism illustrated in FIG. 5, according to the present invention;

FIG. 6C is a front view illustration of the hook mechanism illustrated in FIG. 5, according to the present invention;

FIG. 7A a side view illustration of a preferred ski-boot latch embodiment with exemplary dimensional measurements in accordance with one embodiment of the present invention;

FIG. 7B a top view illustration of the preferred ski-boot latch embodiment illustrated in FIG. 7A with exemplary dimensional measurements in accordance with one embodiment of the present invention;

FIG. 8A is a side view illustration of a first alternative latch with a pin-lock hole and exemplary dimensional measurements in accordance with one embodiment of the present invention;

FIG. 8B is a top view illustration of the first alternative latch illustrated in FIG. 8A with exemplary dimensional measurements in accordance with one embodiment of the present invention;

FIG. 9A a side view illustration of a second alternative latch containing a first alternative mounting means and exemplary dimensional measurements in accordance with one embodiment of the present invention;

FIG. 9B is a top view illustration of the second alternative latch illustrated in FIG. 9A containing a first alternative mounting means and exemplary dimensional measurements in accordance with one embodiment of the present invention;

FIG. 10A is a side view illustration of a third alternative latch containing a second alternative mounting means and exemplary dimensional measurements in accordance with one embodiment of the present invention;

FIG. 10B is a top view illustration of the third alternative latch illustrated in FIG. 10A containing a second alternative mounting means and exemplary dimensional measurements in accordance with one embodiment of the present invention;

FIG. 11A is a side view illustration of a fourth alternative miniature latch containing a third alternative mounting means and exemplary dimensional measurements in accordance with one embodiment of the present invention;

FIG. 11B is a top view of the fourth alternative miniature latch illustrated in FIG. 11A containing a third alternative mounting means and exemplary dimensional measurements in accordance with one embodiment of the present invention;

FIG. 12A is a side view illustration of a fifth alternative miniature latch containing a fourth alternative mounting means and exemplary dimensional measurements in accordance with one embodiment of the present invention; and

FIG. 12B is a top view of the fifth alternative miniature latch illustrated in FIG. 12A containing a fourth alternative mounting means and exemplary dimensional measurements in accordance with one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides enhanced security to the internal components in the main access compartment of a fuel dispenser. Both a primary lock on the main panel, that secures the main access compartment, and a hidden second lock, hidden inside a lower compartment of the fuel dispenser, must be bypassed to gain access to the internal components, thus providing enhanced security. The lower compartment is also protected by a lock, which must be bypassed to open the lower panel and gain access to the hidden second lock in an attempt to bypass the hidden second lock. This locking arrangement provides greater security than prior art methods, since three locks must be bypassed to breach security and gain access to internal components in the main access compartment of the fuel dispenser.

Further, according to the present invention, the main panel includes a hook, wherein the hook attaches to an inside lip on the lower portion of the main panel, and further attaches to a latch within the lower compartment of the fuel dispenser to secure the main panel from unauthorized access.

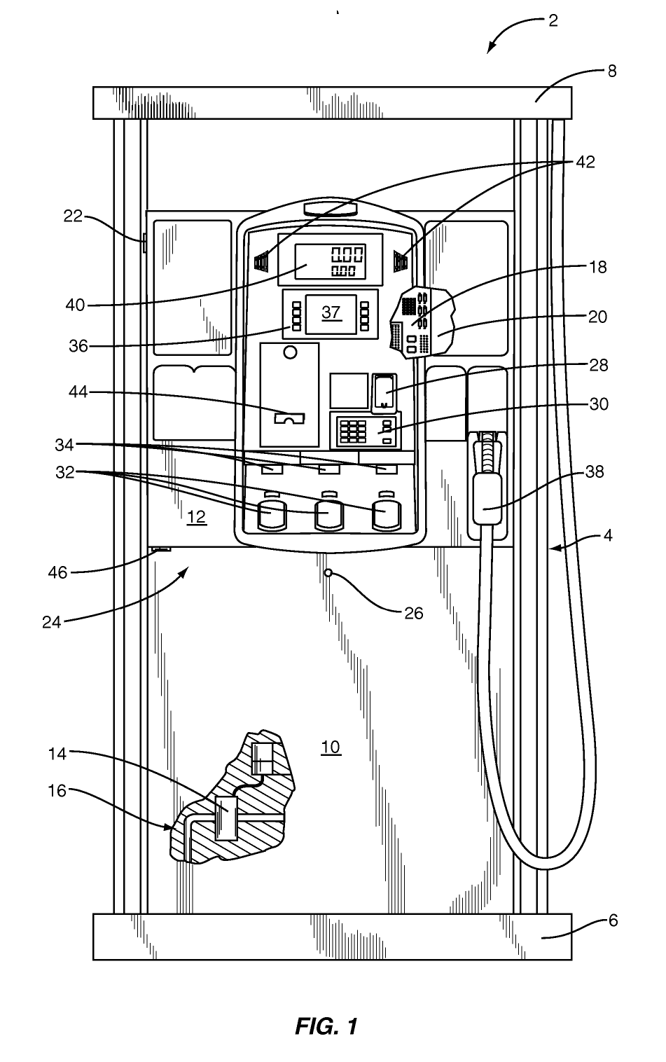

Referring to the drawings, FIG. 1 illustrates an exemplary fuel dispenser 2 of the present invention. The fuel dispenser 2 is comprised of a fuel dispenser housing 4, which is physically coupled to a base stand 6 and may also include an overhead canopy 8 physically coupled to the top of the fuel dispenser housing 4. The fuel dispenser housing 4 further comprises a lower panel 10 and a main panel 12, which separate accessibility to internal fueling components 14 hidden in a lower compartment 16 from internal electrical components 18 residing in a main access compartment 20.

The present invention provides enhanced security to the internal electrical components 18 in the main access compartment 20 of the fuel dispenser 2. Both a primary lock 22 on the main panel 12, that secures access to the main access compartment 20, and a hidden second lock 24, inside the lower compartment 16 of the fuel dispenser 2, must be bypassed to open the main panel 12 and gain access to the internal electrical components 18, thus providing enhanced security. Further, the lower panel 10 is also protected by its own lock 26, which must be bypassed in order to gain access to the lower compartment 16 where the hidden second lock 24 is located. This locking arrangement provides greater security than prior art methods, since three locks, shown here as 22, 24, and 26, must be bypassed to breach security and gain access to the internal electrical components 18 in the main access compartment 20 of the fuel dispenser 2.

FIG. 1 also illustrates the standard components of the fuel dispenser 2, which allow customers to complete a fueling transaction, as are well known to those skilled in the art. A card reader 28 may be provided to allow a customer to pay for the purchase of fuel and/or other merchandise at the fuel dispenser 2. The card reader 28 may be adapted to accept a variety of media and media technologies such as magnetic, bar code, optical, and radio-frequency based technologies, including but not limited to transponders, RFID, and Smartcard technologies. Additionally, a keypad 30 may be provided to allow a customer to use an automated teller machine (ATM)/debit card to complete the purchasing transaction. A grade of fuel is chosen by using fuel grade selection buttons 32, while the price relating to the available grades of fuel are displayed by fuel grade price display screens 34 on the main panel 12. The fuel dispenser 2 may also include a soft-key user interface 36, which is used to select payment options or additional merchandise displayed on a customer screen 37 and desired for purchase at the fuel dispenser 2.

Also, a fuel-dispensing nozzle 38 is provided for the dispensing of fuel, and a transaction display screen 40 displays the price and amount of fuel dispensed during the fueling transaction. The fuel dispenser 2 main panel 12 may also contain speakers 42 to provide audible instructions to the customer should they require assistance. Additionally, the speakers 42 may simply provide audible advertising and/or music to the customer during the fueling transaction. A receipt printer 44 is provided to allow printing of a receipt related to the purchasing and/or fueling transaction. However, the receipt printer 44 may also be capable of printing a transaction code that can be used at a car wash station or other service areas within the service station environment. According to the present invention, the fuel dispenser 2 of FIG. 1 also comprises a hook 46, coupled to the inside lower left portion of the main panel 12, for securing the main panel 12 and deterring unauthorized access to the main access compartment 20. The hook 46 will be described in detail below.

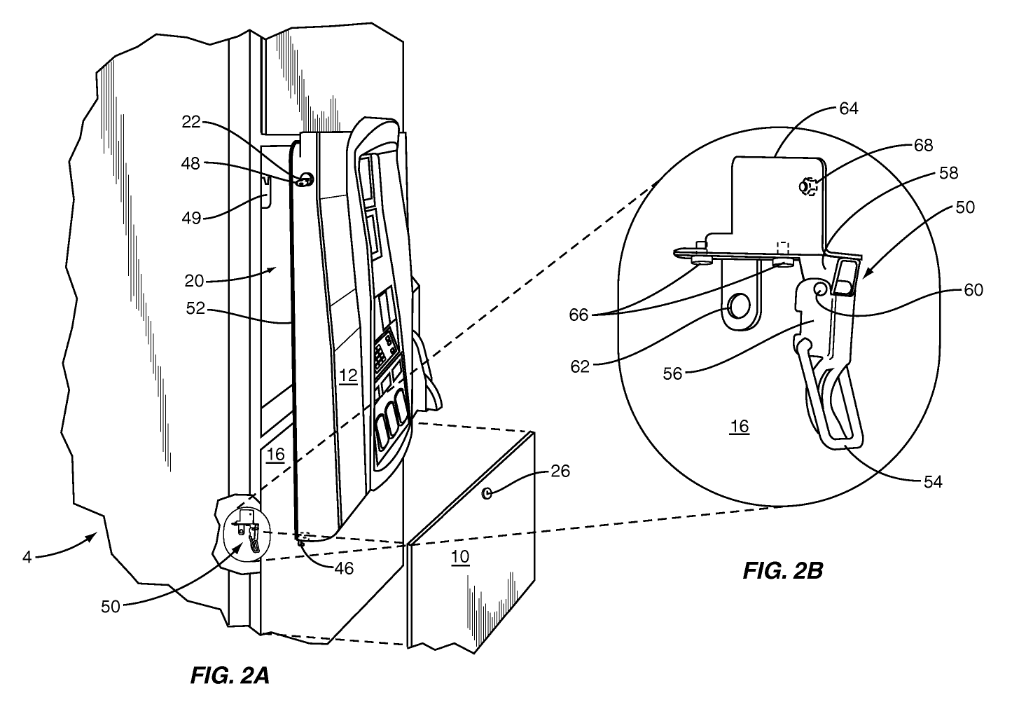

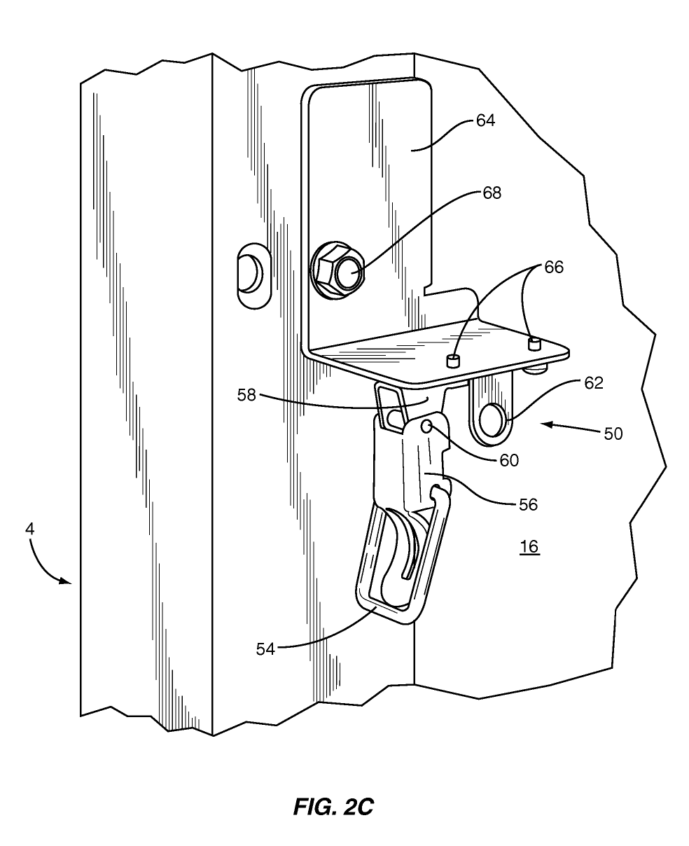

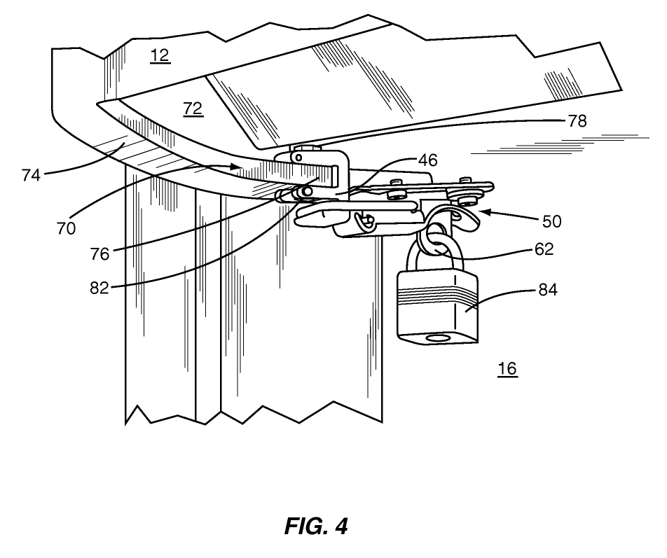

FIG. 2A illustrates an exemplary view of the fuel dispenser 2 with its main panel 12 partially open. To open the main panel 12 and gain access to the internal electrical components 18 within the main access compartment 20, authorized personnel must bypass three locking systems. The primary lock 22 must be unlocked with a primary lock key 48 to disengage the top portion of the main panel 12 from a lock brace 49. Alternatively, retrieval of the primary lock key 48 can only be achieved if the primary lock 22 is in the locked position. In this manner, the main panel 12 will be restricted from fully closing unless the primary lock 22 is in the unlocked position, because the lock brace 49 will impede the main panel from fully closing. Next, in order to free the bottom portion of the main panel 12, the lock 26 on the lower panel 10 must be unlocked in order to remove the lower panel 10 and to gain access to the lower compartment 16. Once access is obtained to the lower compartment 16, the hidden second lock 24 (illustrated in FIG. 4) must be bypassed. The hidden second lock 24 attaches to a ski-boot latch 50 residing in the lower compartment 16, which further couples to the hook 46 on the main panel 12, securing the main panel 12 from unauthorized access. After the hidden second lock 24 is bypassed and the ski-boot latch 50 is unlatched from the hook 46 on the main panel 12, the main panel 12 can be opened to access the main access compartment 20. Additionally, a seal gasket 52 is placed on the main panel 12 to protect the internal electrical components 18 from external weather conditions. In this manner, the primary lock 22 must be locked and the ski-boot latch 50 must be latched in the closed position to ensure that a seal gasket 52 on the main panel 12 is compressed against the fuel dispenser housing 4.

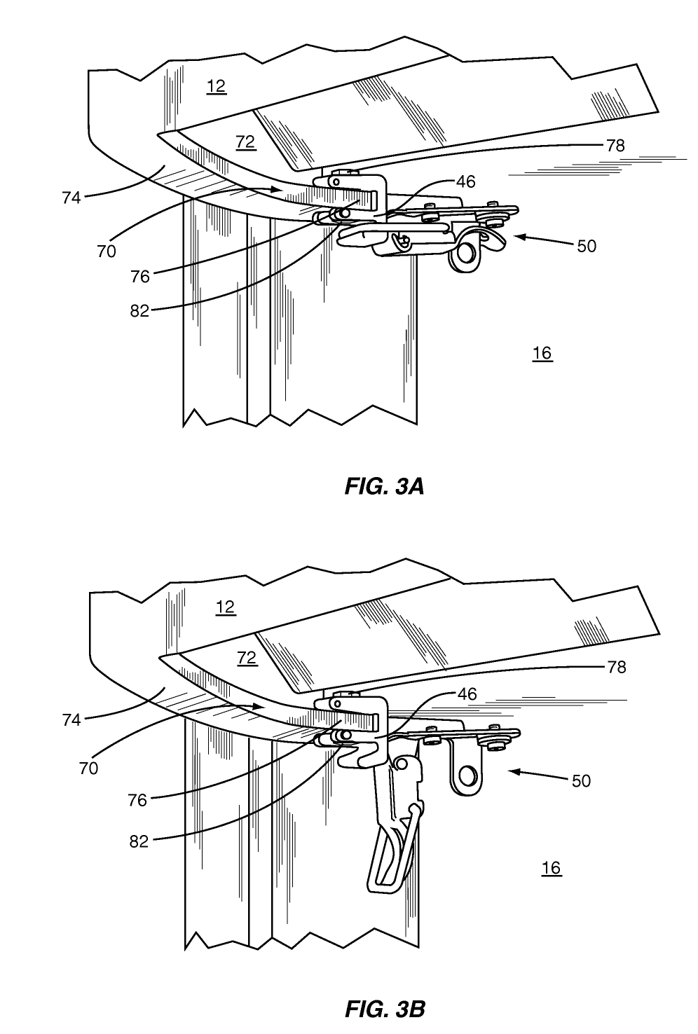

The preferred ski-boot latch 50 and an exemplary means of attachment to the fuel dispenser housing 4 are illustrated in FIGS. 2B and 2C. Referring to FIG. 2B, the preferred ski-boot latch 50 of the present invention includes a hook ring 54, which attaches to the hook 46 on the main panel 12 of the fuel dispenser housing 4. A body lever 56 of the ski-boot latch 50 is coupled to a latch base 58 via an arm pin 60. The body lever 56 swivels about the axis of the arm pin 60, allowing the hook ring 54 to extend outward and physically couple to the hook 46. In this manner, placing the body lever 56 in the closed position (illustrated in FIG. 3A) will secure the bottom portion of the main panel 12 and also compress the related portion of the seal gasket 52.

The preferred embodiment of the ski-boot latch 50 also contains a pad-lock acceptor 62 as an additional measure of security. The implementation of additional locks on the pad-lock acceptor 62 is discussed below. Further, the latch base 58 is physically mounted to a separate metal brace 64 via screws 66. FIG. 2C is an exemplary view showing attachment of the metal brace 64 to the fuel dispenser housing 4 via a bolt 68. According to the present invention, the metal brace 64 is attached to the fuel dispenser housing 4 within the lower compartment 16 of the fuel dispenser housing 4. One ordinarily skilled in the art is aware that there are several ways to attach the bolt 68 to the fuel dispenser housing 4, including, but not limited to, screwing the bolt 68 into a threaded orifice found on the fuel dispenser housing 4 or sliding the bolt 68 through a non-threaded orifice and securing the bolt 68 in place with a nut (not shown) on the opposite side of the orifice.

FIG. 3A shows an exemplary view of the ski-boot latch 50 in the closed position and attached to the hook 46 on the main panel 12 of the fuel dispenser housing 4. The hook 46 is coupled to a lip 70 on the inside lower-left portion of the main panel 12. The lip 70 is physically coupled to front and side 72 of the main panel 12 at a first end 74, while a second end 76 of the lip 70 is open and only physically coupled to the side 72 of the main panel 12. The hook 46 is attached to the second end 76 of the lip 70 via a bolt 78, a washer 80 (not shown), and a nut 82. Further, FIG. 3B shows an exemplary view of the ski-boot latch 50 unlatched from the hook 46 of the main panel 12.

An exemplary view of the ski-boot latch 50 in the closed position with the additionally attached hidden second lock 24 in the form of a pad-lock 84 is illustrated in FIG. 4 and described below. As discussed above, the preferred embodiment ski-boot latch 50 comprises the pad-lock acceptor 62, which will allow service personnel and/or a service station owner to attach the pad-lock 84 for added security. This adds an additional layer of security by forcing those who have bypassed the lock 26 on the lower panel 10 and the primary lock 22 of the main panel 12, to further bypass the attached pad-lock 84 in order to open the main panel 12. Once this pad-lock 84 is unlocked and removed, the ski-boot latch 50 can be opened and disengaged from the hook 46 on the main panel 12 to gain access to the main access compartment 20 of the fuel dispenser 2.

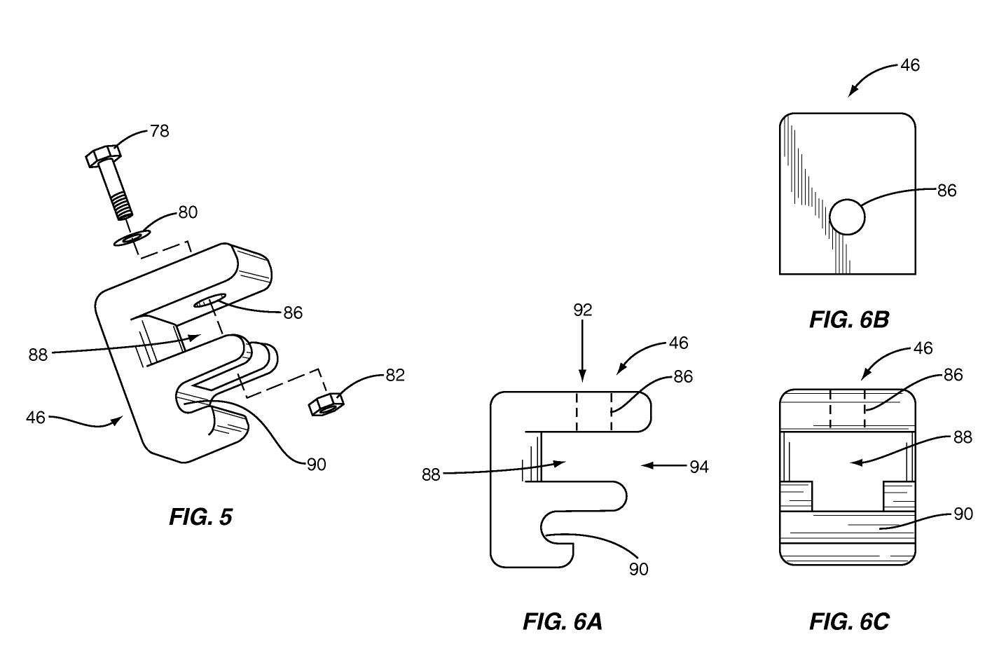

A description of the hook 46, which is used to secure the main panel 12 via the ski-boot latch 50, is presently described. FIG. 5 shows an exploded view of the hook 46 that attaches to the inside lip 70 of the main panel 12. The dashed lines show an exemplary embodiment of how the bolt 78, washer 80, and nut 82 are assembled in attaching the hook 46 to the lip 70. The bolt is inserted through the washer 80 and orifice 86 and proceeds through area 88, where the hook 46 attaches to the second end 76 of the lip 70. The hook 46 is further secured by attaching a nut 82 to the end of the bolt 78. Further, the hook ring 54 of the ski-boot latch 50 attaches to a hook ring attachment area 90 of the hook 46 to secure the main panel 12.

FIGS. 6A-6C show a variety of profile views related to the hook 46. FIG. 6A is a side view illustration of the hook 46 depicting the various elements described above. FIGS. 6B and 6C show top 92 and front 94 view illustrations, respectively, also depicting the various elements of the hook 46 described above.

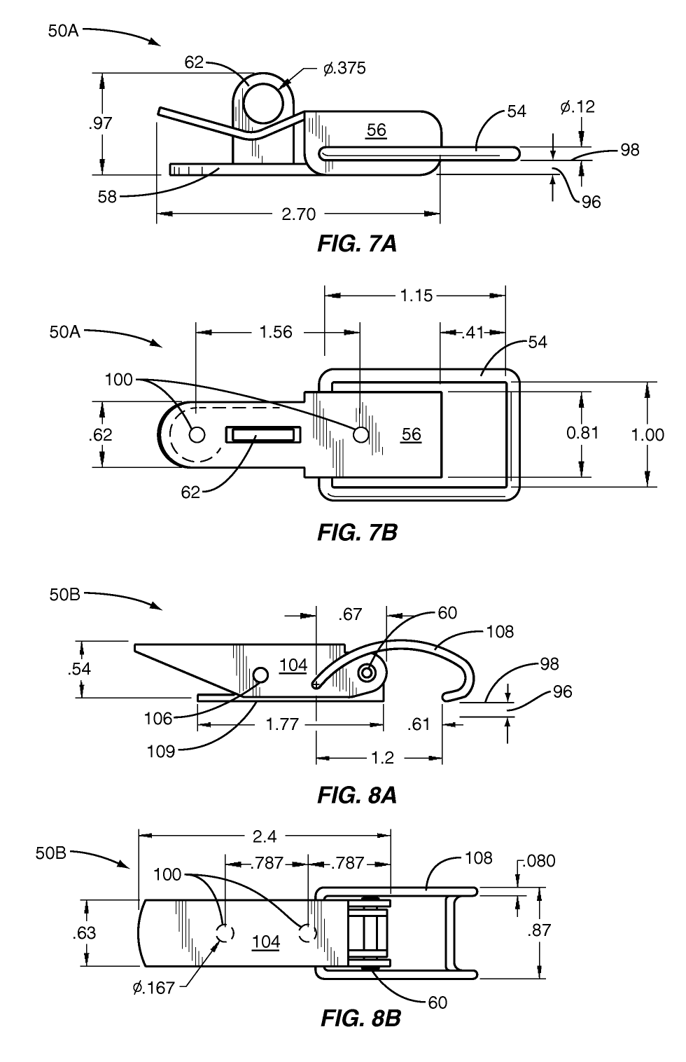

FIGS. 7A-12B illustrate exemplary views of the preferred ski-boot latch 50 embodiment, as well as alternative latch embodiments applicable to the present invention. The dimensional measurements shown in these figures are exemplary and are only shown to demonstrate some of the common latches that are currently available.

FIG. 7A illustrates a side view of a preferred ski-boot latch 50A embodiment of the present invention with exemplary dimensional measurements. Most of the elements previously described in FIG. 2B are, again, shown here. Additionally, a link contact range 96 is shown, relating to the area in which the hook ring 54 can extend below a baseline 98. The baseline 98 is the point at which the hook ring 54 is at its greatest extension when the body lever 56 is in the closed position. FIG. 7B is a top view illustration of the preferred ski-boot latch 50A embodiment. In addition to the exemplary dimensional measurements and previously described components, this view illustrates mounting holes 100 used to attach the ski-boot latch 50A to the metal brace 64 of the preferred embodiment.

FIG. 8A is a side view illustration of a first alternate latch 50B embodiment according to the present invention. Unlike the preferred ski-boot latch 50A embodiment illustrated in FIGS. 7A-7B, this first alternate latch 50B embodiment comprises a pin-lock latch arm 104, which allows for the placement of a lock-pin (not shown) into a pin-lock hole 106. In this manner, the pin-lock latch arm 104 will be obstructed from opening when the lock-pin is in place. The first alternate latch 50B also comprises an alternate curved hook ring 108 used to attach to the hook 46 on the main panel 12 and an alternate latch base 109 that does not contain a pad lock acceptor 62. Similar to the preferred ski-boot latch 50A embodiment, this first alternate latch 50B embodiment contains the arm pin 60, wherein the pin-lock latch arm 104 swivels about the arm pin 60 axis in order to extend outward and attach to the hook 46. This figure also shows similar exemplary dimensional measurements. FIG. 8B further illustrates a top view of this first alternate latch 50B embodiment. From this view, the difference in the mounting hole 100 positions are shown in comparison to the preferred ski-boot latch 50A embodiment.

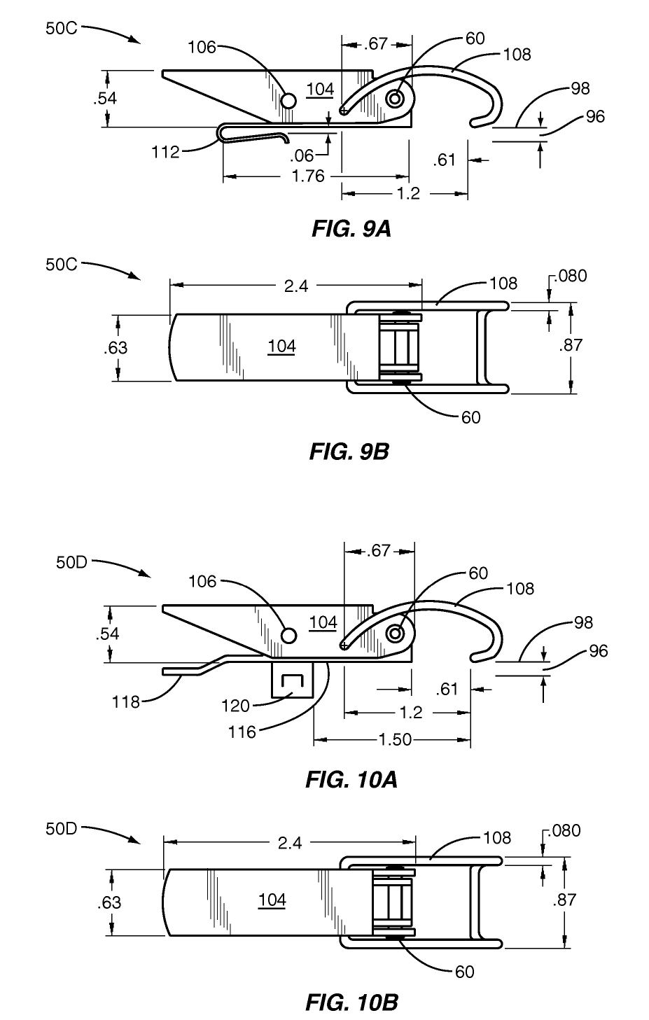

FIG. 9A is a side view illustration of a second alternate latch 50C embodiment according to the present invention. The second alternate latch 50C embodiment differs from the first alternate latch 50B embodiment, illustrated in FIG. 8A, in that the attachment means comprises of an edge-mounting clip 112. An exemplary embodiment of the present invention using this second alternate latch 50C embodiment would couple the edge-mounting clip 112 to the end of the metal brace 64 furthest away from where the curved hook ring 108 would attach to the hook 46, thereby allowing this second alternate latch 50B embodiment to be used as described above according to the present invention. FIG. 9B is a top view illustration of the second alternate latch 50C embodiment, wherein the second alternate latch 50C embodiment does not contain the mounting holes 100 seen in the previous embodiments due to the attachment means of the edge-mounting clip 112.

FIG. 10A is a side view illustration of a third alternate latch 50D embodiment according to the present invention. This third alternate latch 50D embodiment illustrates an alternative latch base 116 comprising a back mounting tab 118 and a side mounting tab 120. FIG. 10B is a top view illustration of the third alternative latch 50D, wherein the third alternate latch 50D embodiment does not contain mounting holes 100 seen in prior embodiments due to the alternative back 118 and side 120 mounting tabs.

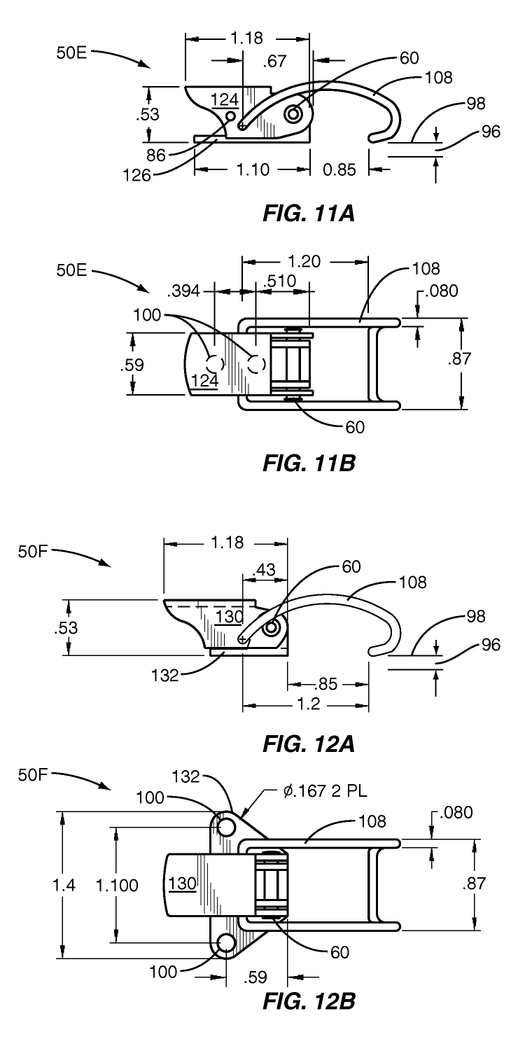

FIG. 11A is a side view illustration of a fourth alternate latch 50E embodiment according to the present invention. The fourth alternate latch 50E comprises a mini-latch arm 124, which is smaller in size than the previous latch arm embodiments. The size of the mini-latch arm 124 requires a greater amount of closing force be applied to place the fourth alternate latch 50E in the closed position, since there is a decrease in leverage force. The exemplary dimensions of the fourth alternate latch 50E also demonstrate the varying distances that the end of the curved hook ring 108 can be set away from the latch base 58. Alternatively, a latch base 126 can be of varying sizes, as seen by comparing FIG. 11A to previous latch base embodiments. Further, the mounting holes 100 seen in the top view of FIG. 11B are closer together due to the decrease in the size of the latch base 126.

FIG. 12A illustrates a side view of a fifth alternate latch 50F embodiment according to the present invention. Unlike the fourth alternate latch 50E embodiment, the fifth alternate latch 50F embodiment comprises a mini-latch arm 130 without a pin-lock hole 106. FIG. 12B also shows that the fifth alternate latch 50F may contain an alternative mounting means comprised of a latch base 132 that extends beyond the edges of the mini-latch arm 130, and where the mounting holes 100 are aligned perpendicular to the length of the fifth alternate latch 50F.

The steps required to properly reassemble and secure the main panel 12 of the fuel dispenser 2 according to the present invention is presently described in detail. As discussed above, FIG. 2A illustrates an exemplary view of the fuel dispenser 2, which has the lower panel 10 and main panel 12 open and/or removed for servicing and in condition to be reassembled. First, the main panel 12 must be placed in the closed position before the lower panel 10 is attached. If this step is not performed, the main panel 12 is obstructed from closing properly, because the hook 46 is impeded by the attached lower panel 10. Additionally, to place the main panel 12 in the closed position, the primary lock 22 is required to be placed in the open position; otherwise the lock brace 49 will obstruct the top portion of the main panel 12 from fully closing. Further, the seal gasket 52 will not seal properly to protect the internal electrical components 18 from external weather conditions if the main panel 12 is not fully closed. Second, the hook ring 54 of the ski-boot latch 50 should be coupled to the hook 46 on the main panel 12. The ski-boot latch 50 is then latched shut, thereby pulling the main panel 12 against the fuel dispenser housing 4 and securing the bottom portion of the main panel 12. Again, this allows the main panel 12 to fully close, thereby allowing the seal gasket 52 to protect the internal electrical components 18 from external weather conditions. Next, the hidden second lock 24, or the pad-lock 84, for instance, can be placed on the pad-lock acceptor 62 of the ski-boot latch 50 for added security, thereby providing a first level of security for the main panel 12. Third, the lower panel 10 is placed over the lower compartment 16 and secured by positioning the lock 26 in the locked position, thereby providing a second level of security for the main panel 12. Finally, the primary lock 22 on the main panel 12 must be placed in the locked position to allow retrieval of the primary lock key 48 by service personnel, thereby providing a third level of security for the main panel 12 of the fuel dispenser 2. This can only be done if the main panel 12 is fully closed, which requires the ski-boot latch 50 to be engaged. Since service personnel will desire to make the fuel dispenser 2 appear re-assembled and, more importantly, retrieve their primary lock key 48, these steps will encourage them to properly secure the main panel 12 of the fuel dispenser 2 according to the present invention.

Those skilled in the art will recognize improvements and modifications to the preferred embodiments of the present invention. All such improvements and modifications are considered within the scope of the concepts disclosed herein and the claims that follow.

What is claimed is:

1. A method for opening a fuel dispenser, comprising:
opening a lower panel on the fuel dispenser that secures a lower compartment of the fuel dispenser;
disengaging a hidden latch assembly located behind the lower panel that is coupled to an upper panel of the fuel dispenser to disengage the upper panel, wherein the upper panel secures an upper compartment of the fuel dispenser and is located adjacent to the lower compartment; and
opening the upper panel after the step of disengaging.

2. The method of claim 1 wherein opening the lower panel comprises unlocking a lower panel lock that secures the lower panel to the lower compartment of the fuel dispenser.

3. The method of claim 1 wherein disengaging the hidden latch assembly further comprises disengaging a ski-boot latch from a hook coupled to the upper panel.

4. The method of claim 3 wherein disengaging the hidden latch assembly further comprises removing a pad-lock from a pad-lock acceptor on the ski boot latch that blocks operation of the ski-boot latch when the pad-lock is inserted into the pad-lock acceptor.

5. The method of claim 4 wherein disengaging the ski-boot latch from the hook further prevents the lower panel from being closed because of interference between the hook and the lower panel.

6. The method of claim 1 wherein opening the upper panel further comprises disengaging a cam locking assembly from a bracket coupled to the upper compartment of the fuel dispenser.

7. The method of claim 6 wherein the cam locking assembly further comprises a lock and disengaging the cam locking assembly from the bracket further comprises inserting a key into the lock and unlocking the lock, wherein unlocking the lock disengages a cam from the bracket and retains the key in the lock.

8. The method of claim 7 further comprising preventing the upper panel from being closed when the lock is in a locked position.

9. A method for closing a fuel dispenser, comprising:
closing an upper panel of the fuel dispenser that secures an upper compartment of the fuel dispenser;
engaging a hidden latch assembly located within a lower compartment of the fuel dispenser that is coupled to the upper panel and secures the upper panel closed when engaged; and
closing a lower panel that secures the lower compartment of the fuel dispenser and hides the hidden latch assembly.

10. A fuel dispenser for providing multi-layered security for a fuel dispenser electronic compartment, comprising:
a housing;
an upper panel adapted to secure an upper compartment in the housing;
a hidden latch assembly located within a lower compartment of the housing and adapted to couple the upper panel when engaged; and
a lower panel adapted to secure the lower compartment and to hide the hidden latch assembly such that the upper panel can be opened by opening the lower panel and disengaging the hidden latch assembly.

11. The fuel dispenser of claim 10 wherein the hidden latch assembly comprises a ski-boot latch and a hook ring, and is adapted to couple the upper panel to the fuel dispenser when the hook ring of the ski-boot latch engages a hook that is secured to the upper panel.

12. The fuel dispenser of claim 11 wherein the ski-boot latch further comprises a slot and the hidden latch assembly further comprises a pad-lock acceptor adapted to pass through the slot when the ski-boot latch is engaged from a disengaged position and to receive a pad-lock to prevent the ski-boot latch from being disengaged when the pad-lock is in place.

13. The fuel dispenser of claim 10 wherein the hidden latch assembly is further adapted to prevent the lower panel from being closed when the hidden latch assembly is in a disengaged position.

14. The fuel dispenser of claim 13 wherein the hidden latch assembly prevents the lower panel from being closed when in the disengaged position by interference of a hook that is coupled to the upper panel with the lower panel.

15. The fuel dispenser of claim 10 wherein the upper panel further comprises a weather seal adapted to exert pressure against the upper panel to prevent the upper panel from being closed when the hidden latch assembly is in a disengaged position.

16. The fuel dispenser of claim 10 wherein the upper panel further comprises a cam locking assembly that further secures the fuel dispenser electronic compartment.

17. The fuel dispenser of claim 16 wherein the cam locking assembly further comprises a lock brace coupled to the fuel dispenser electronic compartment and a lock wherein the lock brace is adapted to prevent opening and closing of the upper panel when the lock is in a locked position.

18. The fuel dispenser of claim 17 wherein the cam locking assembly is further adapted to cause the upper panel to compress a weather seal associated with the upper panel against the fuel dispenser electronic compartment when the lock is engaged with the lock brace and is locked from an unlocked position.

19. The fuel dispenser of claim 16 wherein the cam locking assembly further comprises a lock and the cam locking assembly is further adapted to prevent removal of a key from the lock when the lock is in an unlocked position.

20. The fuel dispenser of claim 16 wherein the cam locking assembly further comprises a lock and the cam locking assembly is further adapted to prevent opening and closing of the upper panel when the lock is in a locked position.
